(19) United States
(12) Patent Application Publication
(10) Pub. No.: US 2020/0398865 A1
(43) Pub. Date: Dec. 24, 2020

(54) PARKING ASSIST SYSTEM

(71) Applicant: HONDA MOTOR CO., LTD., Tokyo (JP)

(72) Inventors: Miki TSUJINO, Saitama (JP); Hiroshi YAMANAKA, Saitama (JP); Yasushi SHODA, Saitama (JP)

(21) Appl. No.: 16/906,694

(22) Filed: Jun. 19, 2020

(30) Foreign Application Priority Data
Jun. 24, 2019 (JP) 2019-116747

(51) Int. Cl. B60W 60/00; B60W 50/14; B60W 30/18; B60R 1/00

(52) U.S. Cl. CPC B60W 60/0025; B60W 50/14; B60W 30/18009; B60R 2300/607; B60W 2420/42; B60W 2050/146; B60R 2300/30; B60R 1/002

(57) ABSTRACT

A parking assist system includes a control device configured to control screen display of a display device, to set a target position candidate selected by an occupant as a target position, and to control an autonomous movement operation to autonomously move a vehicle to the target position to park or unpark the vehicle. The control device is configured to cause the display device to display a look-down image and a bird's-eye image side by side in a target position setting screen and to cause the display device to display the look-down image and a travel direction image, which is an image viewed from the vehicle in the travel direction, side by side in an autonomous movement control screen.

### TECHNICAL FIELD

The present disclosure relates to a parking assist system for autonomously moving a vehicle from a current position to a target position to assist at least one of parking and unparking.

### BACKGROUND ART

A parking and unparking assist device for assisting parking and unparking of a vehicle is known (see JP2018-34645A). In this parking and unparking assist device, parking assist information regarding the parking assist control and unparking assist information regarding the unparking assist control are selectively displayed on a display device depending on the shift position at the time when it is determined to start the control.

In addition, a parking assist device configured to make it easier for the driver to recognize the surroundings of the vehicle is known (see JP2015-74259A). In this parking assist device, when the vehicle is stopped during a target parking position setting control, a display control device causes the display device to display a look-down image without displaying any of the surrounding images of the vehicle captured by multiple imaging devices. When the vehicle is moving forward during the target parking position setting control, the display control device causes the display device to display the look-down image or to display the look-down image and a forward image, without displaying any surrounding image. When the vehicle is moving backward during the target parking position setting control, the display control device causes the display device to display both the look-down image and a rearward image.

Furthermore, a vehicle surroundings display device configured to provide a suitable look-down image in accordance with the travel direction of the vehicle is known (see JP2015-76645A). This vehicle surroundings display device displays, in a screen for target parking position setting control, a travel direction image and a look-down image in accordance with the shift position. In a screen for automatic steering control also, the vehicle surroundings display device displays the travel direction image and the look-down image. However, in the screen for automatic steering control, the vehicle surroundings display device fixes the relative position, orientation and display magnification of the vehicle image indicating the own vehicle in the display area of the look-down image regardless of the travel direction of the vehicle, and when the travel direction of the vehicle switches from forward to backward, expands the display area of the look-down image on the rear side of the vehicle image.

However, in the conventional parking assist systems, only the look-down image or only the look-down image and the travel direction image are displayed in the target parking position setting screen, and therefore, it may be difficult for the occupant to recognize the target parking position and/or the positions of parking position candidates.

### SUMMARY OF THE INVENTION

In view of such a background, an object of the present invention is to provide a parking assist system capable of displaying the target position candidate(s), such as an undelimited parking space defined in the parking area, a delimited parking space, and an unparking space to where the vehicle can be unparked, in a target position setting screen to be easily recognized by the occupant.

In order to solve such problems, an embodiment of the present invention provides a parking assist system (1) for autonomously moving a vehicle from a current position to a target position, the system comprising: an imaging device (19) configured to capture an image of surroundings of the vehicle as a surrounding image; a target position candidate detector (7, 41, 43) configured to detect at least one target position candidate, each target position candidate consisting of an undelimited parking space defined in a parking area around the vehicle, an available delimited parking space (52) around the vehicle, or an unparking space (61) available on a passage; a display device (32) configured to display the surrounding image and the at least one target position candidate on a screen; an operation member (35, 32) configured to receive an operation by an occupant of the vehicle; and a control device (15) configured to control screen display of the display device, to set the target position candidate selected by the occupant via the operation member as the target position, and to control an autonomous movement operation to autonomously move the vehicle to the target position to park or unpark the vehicle, wherein the control device is configured to perform image processing to convert the surrounding image into a look-down image showing the vehicle and a surrounding area of the vehicle as viewed from above and a bird's-eye image showing the vehicle and a part of the surrounding area positioned in a travel direction of the vehicle as viewed from above in the travel direction, to cause the display device to display the look-down image and the bird's-eye image side by side in a target position setting screen in which the at least one target position candidate is displayed for setting the target position, and to cause the display device to display the look-down image and a travel direction image, which is an image viewed from the vehicle in the travel direction, side by side in an autonomous movement control screen displayed when controlling the autonomous movement operation.

According to this configuration, since the control device causes the display device to display the look-down image and the bird's-eye image side by side in the target position setting screen, the target position candidate(s) can be easily recognized by the occupant. Also, the control device causes the display device to display the look-down image and the travel direction image side by side in the autonomous movement control screen, and therefore, the occupant can confirm the travel direction on the screen and check the progress of the autonomous movement operation in the look-down image.

In the above configuration, preferably, the control device is configured to cause the display device to display the at least one target position candidate in the target position setting screen such that the at least one target position candidate is superimposed on at least one of the look-down image and the bird's-eye image.

According to this configuration, since the control device causes the display device to display the target position candidate(s) to be superimposed on at least one of the look-down image and the bird's-eye image in the target position setting screen, the target position candidate(s) can be recognized by the occupant even more easily. This facilitates the setting operation of the target position.

In the above configuration, preferably, the control device is configured to cause the display device to display the target position in the autonomous movement control screen such that the target position is superimposed on at least one of the look-down image and the travel direction image.

According to this configuration, since the control device causes the display device to display the target position to be superimposed on at least one of the look-down image and the bird's-eye image in the autonomous movement control screen, the target position can be easily recognized by the occupant.

In the above configuration, preferably, the control device is configured to cause the display device to display a trajectory to the target position in the autonomous movement control screen such that the trajectory is superimposed on at least one of the look-down image and the travel direction image.

According to this configuration, since the control device causes the display device to display the trajectory to the target position to be superimposed on at least one of the look-down image and the bird's-eye image in the autonomous movement control screen, the trajectory to the target position can be easily recognized by the occupant. In the above configuration, preferably, the parking assist system further comprises an operation input member (11) configured to receive an input of a driving operation of the vehicle by the occupant, wherein when a predetermined operation input by the occupant is received via the operation input member while moving the vehicle by executing the control of the autonomous movement operation, the control device executes a deceleration process to decelerate and stop the vehicle.

According to this configuration, the vehicle is stopped when a predetermined operation input is made during the movement of the vehicle under the control of the autonomous movement operation, and therefore, uneasiness that would be felt by the occupant if the movement of the vehicle were continued can be avoided.

As described above, according to the present invention, it is possible to provide a parking assist system capable of displaying the target position candidate(s) in the target position setting screen to be easily recognized by the occupant.

### BRIEF DESCRIPTION OF THE DRAWINGS

FIG. 1 is a functional block diagram of a vehicle provided with a parking assist system according to an embodiment of the present invention;

FIG. 2 is a flow chart of an automatic parking process;

FIG. 3A is a diagram showing a screen display of a touch panel during a target parking position reception process;

FIG. 3B is a diagram showing the screen display of the touch panel during a driving process;

FIG. 3C is a diagram showing the screen display of the touch panel when automatic parking is completed;

FIG. 4A is a diagram showing the screen display of the touch panel during the target parking position reception process (parking search screen);

FIG. 4B is a diagram showing the screen display of the touch panel during the driving process (parking screen);

FIG. 5 is a flowchart of an automatic unparking process;

FIGS. 6A and 6B are each a diagram showing an example of the screen display of the touch panel during a target unparking position reception process (unparking search screen); and

FIGS. 7A and 7B are each a diagram showing an example of the screen display of the touch panel during the driving process (unparking screen).

### DESCRIPTION OF THE PREFERRED EMBODIMENT(S)

In the following, an embodiment of the present invention will be described in detail with reference to the drawings.

A parking assist system 1 is mounted on a vehicle such as an automobile provided with a vehicle control system 2 configured to make the vehicle travel autonomously.

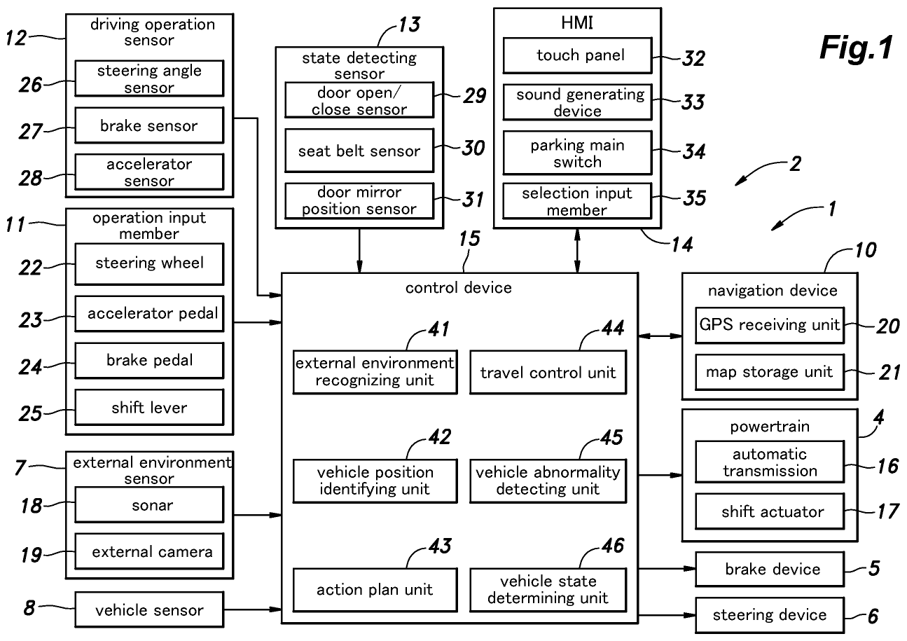

As shown in FIG. 1, the vehicle control system 2 includes a powertrain 4, a brake device 5, a steering device 6, an external environment sensor 7, a vehicle sensor 8, a navigation device 10, an operation input member 11, a driving operation sensor 12, a state detecting sensor 13, a human machine interface (HMI) 14, and a control device 15. The above components of the vehicle control system 2 are connected to each other so that signals can be transmitted therebetween via communication means such as a Controller Area Network (CAN).

The powertrain 4 is a device configured to apply a driving force to the vehicle. The powertrain 4 includes a power source and a transmission, for example. The power source includes at least one of an internal combustion engine, such as a gasoline engine and a diesel engine, and an electric motor. In the present embodiment, the powertrain 4 includes an automatic transmission 16 and a shift actuator 17 for changing a shift position of the automatic transmission 16 (a shift position of the vehicle). The brake device 5 is a device configured to apply a brake force to the vehicle. For example, the brake device 5 includes a brake caliper configured to press a brake pad against a brake rotor and an electric cylinder configured to supply an oil pressure to the brake caliper. The brake device 5 may include an electric parking brake device configured to restrict rotations of wheels via wire cables. The steering device 6 is a device for changing a steering angle of the wheels. For example, the steering device 6 includes a rack-and-pinion mechanism configured to steer (turn) the wheels and an electric motor configured to drive the rack-and-pinion mechanism. The powertrain 4, the brake device 5, and the steering device 6 are controlled by the control device 15.

The external environment sensor 7 serves as an external environment information acquisition device for detecting electromagnetic waves, sound waves, and the like from the surroundings of the vehicle to detect an object outside the vehicle and to acquire surrounding information of the vehicle. The external environment sensor 7 includes sonars 18 and external cameras 19. The external environment sensor 7 may further include a millimeter wave radar and/or a laser lidar. The external environment sensor 7 outputs a detection result to the control device 15.

Each sonar 18 consists of a so-called ultrasonic sensor. Each sonar 18 emits ultrasonic waves to the surroundings of the vehicle and captures the ultrasonic waves reflected by an object around the vehicle thereby to detect a position (distance and direction) of the object. Multiple sonars 18 are provided at each of a rear part and a front part of the vehicle. In the present embodiment, two pairs of sonars 18 are provided on a rear bumper so as to be spaced laterally from each other, two pairs of sonars 18 are provided on a front bumper so as to be spaced laterally from each other, one pair of sonars 18 is provided at a front end portion of the vehicle such that the two sonars 18 forming the pair are provided on left and right side faces of the front end portion of the vehicle, and one pair of sonars 18 is provided at a rear end portion of the vehicle such that the two sonars 18 forming the pair are provided on left and right side faces of the rear end portion of the vehicle. That is, the vehicle is provided with six pairs of sonars 18 in total. The sonars 18 provided on the rear bumper mainly detect positions of objects behind the vehicle. The sonars 18 provided on the front bumper mainly detect positions of objects in front of the vehicle. The sonars 18 provided at the left and right side faces of the front end portion of the vehicle detect positions of objects on left and right outsides of the front end portion of the vehicle, respectively. The sonars 18 provided at the left and right side faces of the rear end portion of the vehicle detect positions of objects on left and right outsides of the rear end portion of the vehicle, respectively.

The external cameras 19 are devices configured to capture images around the vehicle. Each external camera 19 consists of a digital camera using a solid imaging element such as a CCD or a CMOS, for example. The external cameras 19 include a front camera for capturing an image in front of the vehicle and a rear camera for capturing an image to the rear of the vehicle. The external cameras 19 may include a pair of left and right side cameras that are provided in the vicinity of the door mirrors of the vehicle to capture images on left and right sides of the vehicle.

The vehicle sensor 8 includes a vehicle speed sensor configured to detect the speed of the vehicle, an acceleration sensor configured to detect the acceleration of the vehicle, a yaw rate sensor configured to detect the angular velocity around a vertical axis of the vehicle, and a direction sensor configured to detect the direction of the vehicle. For example, the yaw rate sensor consists of a gyro sensor.

The navigation device 10 is a device configured to obtain a current position of the vehicle and provides route guidance to a destination and the like. The navigation device 10 includes a GPS receiving unit 20 and a map storage unit 21. The GPS receiving unit 20 identifies a position (latitude and longitude) of the vehicle based on a signal received from an artificial satellite (positioning satellite). The map storage unit 21 consists of a known storage device such as a flash memory or a hard disk, and stores map information.

The operation input member 11 is provided in a vehicle cabin to receive an input operation performed by the occupant (user) to control the vehicle. The operation input member 11 includes a steering wheel 22, an accelerator pedal 23, a brake pedal 24 (brake input member), and a shift lever 25 (a shift member). The shift lever 25 is configured to receive an operation for selecting the shift position of the vehicle.

The driving operation sensor 12 detects an operation amount of the operation input member 11. The driving operation sensor 12 includes a steering angle sensor 26 configured to detect a steering angle of the steering wheel 22, a brake sensor 27 configured to detect a pressing amount of the brake pedal 24, and an accelerator sensor 28 configured to detect a pressing amount of the accelerator pedal 23. The driving operation sensor 12 outputs a detected operation amount to the control device 15.

The state detecting sensor 13 is a sensor configured to detect a change in a state of the vehicle according to an operation by the occupant. The operation by the occupant detected by the state detecting sensor 13 includes an operation indicating an alighting intention (intention to alight from the vehicle) of the occupant and an operation indicating absence of an intention of the occupant to check the surroundings of the vehicle during an autonomous parking operation or an autonomous unparking operation. The state detecting sensor 13 includes, as sensors for detecting the operation indicating the alighting intention, a door open/close sensor 29 configured to detect opening and/or closing of a door of the vehicle and a seat belt sensor 30 configured to detect a fastening state of a seat belt. The state detecting sensor 13 includes, as a sensor to detect the operation corresponding to the abdicating intention, a door mirror position sensor 31 configured to detect a position of a door mirror. The state detecting sensor 13 outputs a signal indicating a detected change in the state of the vehicle to the control device 15.

The HMI 14 is an input/output device for receiving an input operation by the occupant and notifying the occupant of various kinds of information by display and/or voice. The HMI 14 includes, for example, a touch panel 32 that includes a display screen such as a liquid crystal display or an organic EL display and is configured to receive the input operation by the occupant, a sound generating device 33 such as a buzzer or a speaker, a parking main switch 34, and a selection input member 35. The parking main switch 34 receives the input operation by the occupant to execute selected one of an automatic parking process (autonomous parking operation) and an automatic unparking process (autonomous unparking operation). The parking main switch 34 is a so-called momentary switch that is turned on only while a pressing operation (pushing operation) is performed by the occupant. The selection input member 35 receives a selection operation by the occupant related to selection of the automatic parking process and the automatic unparking process. The selection input member 35 may consist of a rotary select switch, which preferably requires pressing as the selection operation.

The control device 15 consists of an electronic control unit (ECU) that includes a CPU, a nonvolatile memory such as a ROM, a volatile memory such as a RAM, and the like. The CPU executes operation processing according to a program so that the control device 15 executes various types of vehicle control. The control device 15 may consist of one piece of hardware, or may consist of a unit including multiple pieces of hardware. Further, the functions of the control device 15 may be at least partially executed by hardware such as an LSI, an ASIC, and an FPGA, or may be executed by a combination of software and hardware.

Further, the control device 15 executes an arithmetic process according to a program and thereby performs a conversion process of an image (video) captured by the external cameras 19 so as to generate a look-down image corresponding to a plan view of the vehicle and its surrounding area and a bird's-eye image corresponding to a three-dimensional image of the vehicle and a part of its surrounding area positioned in the travel direction as viewed from above. The control device 15 may generate the look-down image by combining the images of the front camera, the rear camera, and the left and right side cameras, and may generate the bird's-eye image by combining the image captured by the front camera or the rear camera facing the travel direction and the images captured by the left and right side cameras.

The parking assist system 1 is a system for executing the so-called automatic parking process and the so-called automatic unparking process, in which a vehicle is moved autonomously to a prescribed target position (a target parking position or a target unparking position) selected by the occupant so as to park or unpark the vehicle.

The parking assist system 1 is constituted of the control device 15, the external environment sensor 7 (the sonars 18 and the external cameras 19) serving as a target position candidate detector, the touch panel 32 serving as a display device on which a selection operation can be performed, the external cameras 19 serving as an imaging device, the selection input member 35, and the operation input member 11.

The control device 15 controls the powertrain 4, the brake device 5, and the steering device 6 so as to execute an autonomous parking operation to move the vehicle autonomously to a target parking position and park the vehicle at the target parking position and an autonomous unparking operation to move the vehicle autonomously to a target unparking position and unpark the vehicle at the target unparking position. In order to execute such operations, the control device 15 includes an external environment recognizing unit 41, a vehicle position identifying unit 42, an action plan unit 43, a travel control unit 44, a vehicle abnormality detecting unit 45, and a vehicle state determining unit 46.

The external environment recognizing unit 41 recognizes an obstacle (for example, a parked vehicle or a wall) that is present around the vehicle based on the detection result of the external environment sensor 7, and thereby obtains information about the obstacle. Further, the external environment recognizing unit 41 analyzes the images captured by the external cameras 19 based on a known image analysis method such as pattern matching, and thereby determines whether a wheel stopper or an obstacle is present, and obtains the size of the wheel stopper or the obstacle in a case where the wheel stopper or the obstacle is present. Further, the external environment recognizing unit 41 may compute a distance to the obstacle based on signals from the sonars 18 to obtain the position of the obstacle.

Also, by the analysis of the detection result of the external environment sensor 7 (more specifically, by the analysis of the images captured by the external cameras 19 based on a known image analysis method such as pattern matching), the external environment recognizing unit 41 can acquire, for example, a lane on a road delimited by road signs and a parking space delimited by white lines and the like provided on a surface of a road, a parking lot, and the like.

The vehicle position identifying unit 42 identifies the position of the vehicle (the own vehicle) based on a signal from the GPS receiving unit 20 of the navigation device 10. Further, the vehicle position identifying unit 42 may obtain the vehicle speed and the yaw rate from the vehicle sensor 8, in addition to the signal from the GPS receiving unit 20, and identify the position and posture of the vehicle by the so-called inertial navigation.

The travel control unit 44 controls the powertrain 4, the brake device 5, and the steering device 6 based on a travel control instruction from the action plan unit 43 to make the vehicle travel.

The vehicle abnormality detecting unit 45 detects an abnormality of the vehicle (hereinafter referred to as “vehicle abnormality”) based on signals from various devices and sensors. The vehicle abnormality detected by the vehicle abnormality detecting unit 45 includes failure of various devices necessary for driving the vehicle (for example, the powertrain 4, the brake device 5, and the steering device 6) and failure of various sensors necessary for making the vehicle travel autonomously (for example, the external environment sensor 7, the vehicle sensor 8, and the GPS receiving unit 20). Further, the vehicle abnormality includes failure of the HMI 14.

The vehicle state determining unit 46 acquires the state of the vehicle based on signals from various sensors provided in the vehicle, and determines whether the vehicle is in a prohibition state in which the autonomous movement (namely, the autonomous parking operation or the autonomous unparking operation) of the vehicle should be prohibited. The vehicle state determining unit 46 determines that the vehicle is in the prohibition state when the occupant performs a driving operation (override operation) of the operation input member 11. The override operation is an operation to override (cancel) the autonomous movement (namely, the autonomous parking operation or the autonomous unparking operation) of the vehicle.

More specifically, the vehicle state determining unit 46 may determine the initiation of the override operation when the pressing amount of the brake pedal 24 acquired (detected) by the brake sensor 27 has reached or exceeded a prescribed threshold (hereinafter referred to as “pressing threshold”). Additionally or alternatively, the vehicle state determining unit 46 may determine the initiation of the override operation when a pressing amount of the accelerator pedal 23 acquired (detected) by the accelerator sensor 28 has reached or exceeded a prescribed threshold. The vehicle state determining unit 46 may also determine the initiation of the override operation when a changing rate of the steering angle obtained (detected) by the steering angle sensor 26 has reached or exceeded a prescribed threshold.

Further, the vehicle state determining unit 46 determines, based on the detection result of the state detecting sensor 13, that the vehicle is in the prohibition state when the vehicle is in a state that reflects the alighting intention (intention to alight from the vehicle) of the occupant. More specifically, when the door open/close sensor 29 detects that the door is opened, the vehicle state determining unit 46 determines that the vehicle is in the prohibition state. Also, when the seat belt sensor 30 detects that the seat belt is released, the vehicle state determining unit 46 determines that the vehicle is in the prohibition state.

The action plan unit 43 executes the automatic parking process (autonomous parking operation) or the automatic unparking process (autonomous unparking operation) when the vehicle is in a prescribed state and the HMI 14 or the parking main switch 34 receives a prescribed input by the user, which corresponds to a request for the automatic parking process or the automatic unparking process. More specifically, the action plan unit 43 executes the automatic parking process in a case where a prescribed input corresponding to the automatic parking process is performed when the vehicle is stopped or the vehicle is traveling at a low speed equal to or less than a prescribed vehicle speed (a vehicle speed at which a parking position candidate can be searched for). The action plan unit 43 executes the automatic unparking process (parallel unparking process) in a case where a prescribed input corresponding to the automatic unparking process is performed when the vehicle is stopped. The selection of the process to be executed (the automatic parking process or the automatic unparking process) may be made by the action plan unit 43 based on the state of the vehicle. Alternatively, the above selection may be made by the occupant via the touch panel 32 or the selection input member 35. When executing the automatic parking process, the action plan unit 43 first makes the touch panel 32 display a parking search screen for setting the target parking position. After the target parking position is set, the action plan unit 43 makes the touch panel 32 display a parking screen. When executing the automatic unparking process, the action plan unit 43 first makes the touch panel 32 display an unparking search screen for setting the target unparking position. After the target unparking position is set, the action plan unit 43 makes the touch panel 32 display an unparking screen.

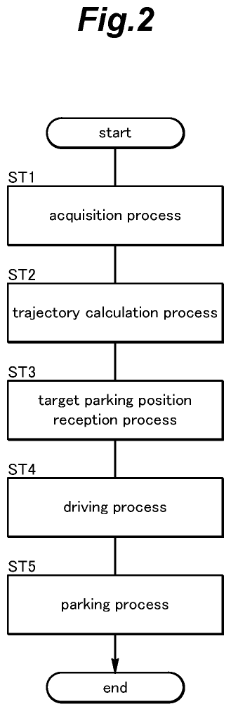

In the following, the automatic parking process will be described with reference to FIG. 2. The action plan unit 43 first executes an acquisition process (step ST1) to acquire one or more parking spaces, if any. More specifically, in a case where the vehicle is stopped, the action plan unit 43 first makes the touch panel 32 of the HMI 14 display a notification that instructs the occupant to move the vehicle straight. While the occupant sitting in the driver's seat (hereinafter referred to as “driver”) is moving the vehicle straight, the external environment recognizing unit 41 acquires, based on a signal from the external environment sensor 7, a position and size of each detected obstacle and positions of the white lines provided on the road surface. The external environment recognizing unit 41 extracts, based on the acquired position and size of the obstacle and the acquired positions of the white lines, one or more undelimited parking spaces and one or more delimited parking spaces, if any (hereinafter, the undelimited parking spaces and the delimited parking spaces will be collectively referred to as “parking spaces”). Each undelimited parking space is a space that is not delimited by the white lines or the like, has a size sufficient to park the vehicle, and is available (namely, there is no obstacle therein). Each delimited parking space is a space that is delimited by the white lines or the like, has a size sufficient to park the vehicle, and is available (namely, another vehicle (vehicle other than the own vehicle) is not parked).

Next, the action plan unit 43 executes a trajectory calculation process (step ST2) to calculate a trajectory of the vehicle from a current position of the vehicle to each extracted parking space. In a case where the trajectory of the vehicle can be calculated for a certain parking space, the action plan unit 43 sets the parking space as a parking position candidate where the vehicle can be parked, and make the touch panel 32 display the parking position candidate on the screen (the parking search screen). In a case where the trajectory of the vehicle cannot be calculated due to the presence of the obstacle, the action plan unit 43 does not set the parking space as a parking position candidate and does not make the touch panel 32 display the parking space on the screen. When the action plan unit 43 sets multiple parking position candidates (namely, multiple parking places for which the trajectory of the vehicle can be calculated), the action plan unit 43 makes the touch panel 32 display these parking position candidates.

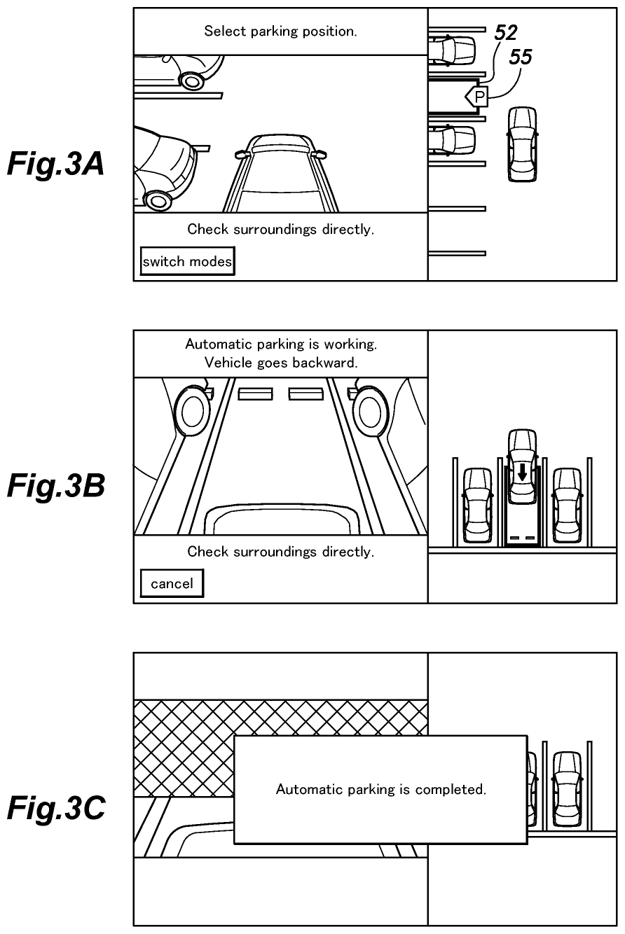

Next, the action plan unit 43 executes a target parking position reception process (step ST3) to receive a selection operation performed by the occupant to select the target parking position, which is a parking position where the occupant wants to park the vehicle, and is selected from the one or more parking position candidates displayed on the touch panel 32. More specifically, the action plan unit 43 makes the touch panel 32 display the look-down image and the bird's-eye image in the travel direction on the parking search screen shown in FIG. 3A. When the action plan unit 43 acquires at least one parking position candidate, the action plan unit 43 makes the touch panel 32 display a frame that indicates the parking position candidate and an icon that corresponds to the frame in at least one of the look-down image and the bird's-eye image (in the look-down image in FIG. 3A) in an overlapping manner. The icon consists of a symbol indicating the parking position candidate (see “P” in FIG. 3A). Also, the action plan unit 43 makes the touch panel 32 display the parking search screen including a notification that instructs the driver to stop the vehicle and select the target parking position, so that the touch panel 32 receives the selection operation of the target parking position. The selection operation of the target parking position may be performed via the touch panel 32, or may be performed via the selection input member 35.

After the vehicle is stopped and the target parking position is selected by the driver, the action plan unit 43 makes the touch panel 32 switch the screen from the parking search screen to the parking screen. As shown in FIG. 3B, the parking screen is a screen in which an image in the travel direction of the vehicle (hereinafter referred to as “travel direction image”) is displayed on the left half of the touch panel 32 and the look-down image including the vehicle and its surrounding area is displayed on the right half thereof. At this time, the action plan unit 43 may make the touch panel 32 display a thick frame that indicates the target parking position selected from the parking position candidates and an icon that corresponds to the thick frame such that the thick frame and the icon overlap with the look-down image. This icon consists of a symbol indicating the target parking position, and is shown in a color different from the symbol indicating the parking position candidate.

After the target parking position is selected and the screen of the touch panel 32 is switched to the parking screen, the action plan unit 43 executes a driving process (step ST4) to make the vehicle travel along the calculated trajectory. At this time, the action plan unit 43 controls the vehicle based on the position of the vehicle acquired by the GPS receiving unit 20 and the signals from the external cameras 19, the vehicle sensor 8, and the like so that the vehicle travels along the calculated trajectory. At this time, the action plan unit 43 controls the powertrain 4, the brake device 5, and the steering device 6 so as to execute a switching operation for switching the travel direction of the vehicle (a reversing operation for reversing the travel direction of the vehicle). The switching operation may be executed repeatedly, or may be executed only once.

During the driving process, the action plan unit 43 may acquire the travel direction image from the external cameras 19 and make the touch panel 32 display the acquired travel direction image on the left half thereof. For example, as shown in FIG. 3B, when the vehicle is moving backward, the action plan unit 43 may make the touch panel 32 display an image to the rear of the vehicle captured by the external cameras 19 on the left half thereof. While the action plan unit 43 is executing the driving process, the surrounding image of the vehicle (the own vehicle) in the look-down image displayed on the right half of the touch panel 32 changes along with the movement of the vehicle. When the vehicle reaches the target parking position, the action plan unit 43 stops the vehicle and ends the driving process.

When the vehicle state determining unit 46 determines that the vehicle is in the prohibition state during the driving process, the action plan unit 43 displays a notification that the automatic parking is suspended or canceled on the touch panel 32 and executes a deceleration process to decelerate the vehicle to stop the same. Thus, when there is a predetermined operation input by the occupant via the operation input member 11, the action plan unit 43 executes the deceleration process, whereby uneasiness that would be felt by the occupant if the movement of the vehicle were continued can be avoided.

When the driving process ends, the action plan unit 43 executes a parking process (step ST5). In the parking process, the action plan unit 43 first drives the shift actuator 17 to set the shift position (shift range) to a parking position (parking range). Thereafter, the action plan unit 43 drives the parking brake device, and makes the touch panel 32 display a pop-up window (see FIG. 3C) indicating that the automatic parking of the vehicle has been completed. The pop-up window may be displayed on the screen of the touch panel 32 for a prescribed period. Thereafter, the action plan unit 43 may make the touch panel 32 switch the screen to an operation screen of the navigation device 10 or a map screen.

In the parking process, there may be a case where the shift position cannot be changed to the parking position because of an abnormality of the shift actuator 17 or a case where the parking brake device cannot be driven because of an abnormality of the parking brake device. In these cases, the action plan unit 43 may make the touch panel 32 display the cause of the abnormality on the screen thereof.

Next, the automatic parking process will be described in more detail. The external environment recognizing unit 41 and the action plan unit 43 perform the acquisition process and the trajectory calculation process in steps ST1 and ST2 as described above. In the acquisition process, the external environment recognizing unit 41 detects one or more parking spaces (positions where the vehicle can be parked) based on the detection result of the external environment sensor 7 (the sonars 18 and the external cameras 19).

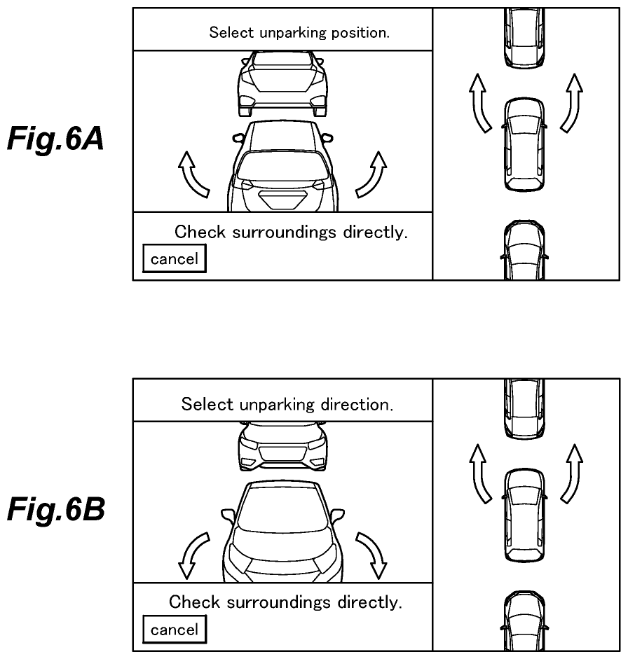

Specifically, based on the detection result of the sonars 18, the external environment recognizing unit 41 detects an area around the vehicle that is larger than the vehicle and other than passages and objects (obstacles that hinder the travel of the vehicle), and sets the detected area as a parking area (see FIG. 6). To detect the parking area, the external environment recognizing unit 41 detects obstacles within a range of, for example, about 7 to 8 m on either side of the vehicle with respect to the vehicle traveling at a low speed or stopped.

The external environment recognizing unit 41 determines the type of the parking area based on the detected size (size in plan view) of the parking area. The types of the parking area include a perpendicular parking area in which the vehicle can be parked in perpendicular parking, a parallel parking area in which the vehicle can be parked in parallel parking, and an angle parking area in which the vehicle can be parked in angle parking.

In a case where the detected space satisfies the parking size for one vehicle of a certain type (for example, 2.5 m×5 m (in the case of perpendicular parking) or 2 m×7 m (in the case of parallel parking)) but does not satisfy the parking size for two vehicles (for example, 5 m×5 m or 2 m×14 m), the external environment recognizing unit 41 sets a rectangular undelimited parking space (see FIG. 6), in which the vehicle should be parked, substantially in the center of the detected parking area. At this time, the external environment recognizing unit 41 preferably sets the position of the undelimited parking space in a range away from the vehicle laterally by about 1 to 2 m. The external environment recognizing unit 41 may set the position of the undelimited parking space depending on the position of the detected obstacle(s). The undelimited parking space is a vacant (or available) undelimited space with a sufficient size for parking the vehicle as explained above regarding the parking space. When the trajectory of the vehicle from the current position of the vehicle to the undelimited parking space can be calculated by the trajectory calculation process in step ST2, the action plan unit 43 sets the undelimited parking space as a parking position candidate.

In a case where the detected parking area has a depth (depth in the vehicle width direction) sufficient to park the vehicle in perpendicular parking (for example, 6 m) and a width (an opening size in the vehicle travel direction) larger than a perpendicular parking size for two vehicles (for example, 5 m), the external environment recognizing unit 41 sets multiple undelimited parking spaces arranged for perpendicular parking so that the maximum number of vehicles can be parked in the detected parking area, and, after performing the trajectory calculation process for these undelimited parking space, the action plan unit 43 sets them as parking position candidates. Thereby, multiple undelimited parking spaces are set in the large parking area, and therefore, the occupant can select, as a target parking position, a parking position in which the occupant desires to park the vehicle from among the multiple undelimited parking spaces set in the parking area.

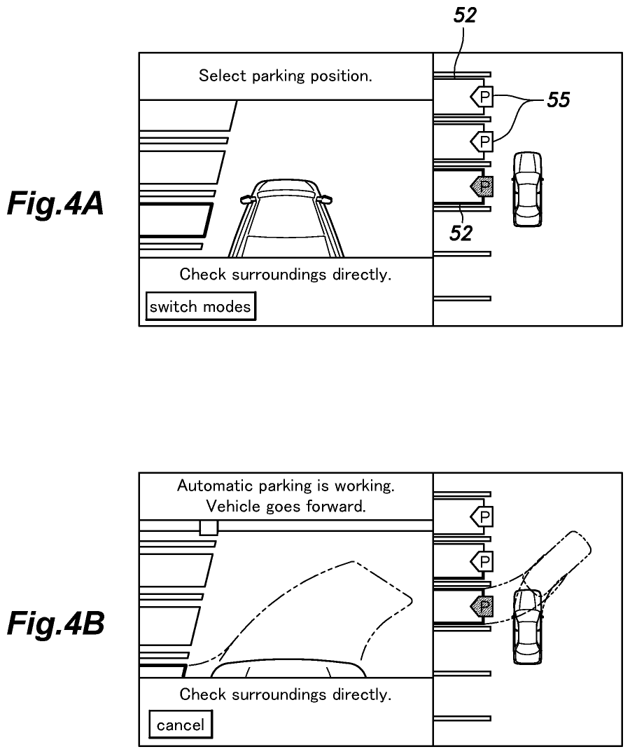

Also, the action plan unit 43 may coordinate the parking position candidates by using both the detection result of the sonars 18 and the detection result of the external cameras 19. Specifically, when delimiting lines, such as white lines, that define delimited parking spaces 52 (FIG. 4) can be clearly detected, the action plan unit 43 preferentially sets the delimited parking spaces 52 detected by the external cameras 19 as parking position candidates. When there are no delimiting lines that can be detected by the external cameras 19, the action plan unit 43 sets the undelimited parking spaces set in the parking area detected by the sonars 18 as parking position candidates. When the delimiting lines are unclearly detected by the external cameras 19, the action plan unit 43 adjusts the position of one or more undelimited parking spaces detected by the sonars 18 in accordance with the position of the delimiting lines and sets the one or more undelimited parking spaces as parking position candidates.

In this way, the external environment sensor 7 (the sonars 18 and the external cameras 19), the external environment recognizing unit 41, and the action plan unit 43 cooperate with each other to function as a target position candidate detector configured to detect, as the parking position candidates, the undelimited parking spaces set in the parking area around the vehicle and/or the delimited parking spaces (available delimited spaces for parking) 52 around the vehicle. Namely, the target position candidate detector is configured to detect at least one target position candidate, each consisting of an undelimited parking space set in the parking area around the vehicle or a delimited parking space 52 around the vehicle.

The action plan unit 43 performs the trajectory calculation process for all of the undelimited parking spaces and thereafter sets them as parking position candidates. In addition, the action plan unit 43 performs the trajectory calculation for the available (vacant) delimited parking spaces 52 detected by the external cameras 19 and when the trajectory of the vehicle can be calculated for some delimited parking spaces 52, sets these delimited parking spaces 52 as parking position candidates.

The action plan unit 43 displays a frame indicating the detected parking position candidate on the screen of the touch panel 32 as described above. When multiple parking position candidates are detected, the action plan unit 43 displays frames indicating the respective parking position candidates on the screen of the touch panel 32. However, in the action plan unit 43, an upper limit number of the parking position candidates to be displayed on the touch panel 32 is set, and when the number of the detected parking position candidates exceeds the upper limit number, the action plan unit 43 performs a parking position candidate selection process of selecting the parking position candidates to be displayed on the touch panel 32 from the detected parking position candidates according to the predetermined rule. In the present embodiment, the upper limit number of the parking position candidates displayed on the touch panel 32 is set to 3.

As described with reference to FIG. 3A, in the parking search screen, the action plan unit 43 displays the look-down image and the bird's-eye image side by side on the touch panel 32. That is, the action plan unit 43 is configured to be capable of performing image processing to convert the surrounding image captured by the external cameras 19 into the look-down image and the bird's-eye image. Thereby, the parking position candidates and the target parking position are displayed to be easily recognized by the occupant. Further, as described with reference to FIG. 3B, in the parking screen, the action plan unit 43 displays the look-down image and the travel direction image side by side on the touch panel 32. Thereby, the occupant can confirm the travel direction on the screen and check the progress of the autonomous movement operation in the automatic parking process in the look-down image.

Here, the look-down image is an image of the vehicle and its surroundings viewed from above. The look-down image is displayed with the front of the vehicle facing upward on the screen, and an image representing the vehicle is composited in the center of the surrounding image. The bird's-eye image is an image of the vehicle and a part of the surrounding area of the vehicle positioned in the travel direction as viewed downward in the travel direction from a view point above the vehicle and shifted in the direction opposite to the travel direction. The bird's-eye image is displayed so that the travel direction of the vehicle coincides with the upward direction of the screen, and an image representing the vehicle is composited at the bottom of the (partial) surrounding image. When the vehicle is moving forward, the bird's-eye image is an image of the vehicle and an area in front of the vehicle as viewed downward in the forward direction from a view point above and rear of the vehicle. When the vehicle is moving backward, the bird's-eye image is an image of the vehicle and an area to the rear of the vehicle as viewed downward in the rear direction from a view point above and front of vehicle. It should be noted that the determination as to whether the vehicle is moving forward or backward may be made based on the vehicle speed or the shift range. The bird's-eye image when the vehicle is stopped or in the parking range may be an image of the vehicle and the front area as viewed forward and downward as in the same manner as when the vehicle is moving forward.

As shown in FIG. 4A, in the parking search screen, the action plan unit 43 displays the upper limit number (3 in the present embodiment) of parking position candidates as rectangular frames and also displays the same number of icons 55 for selection so as to be associated with the corresponding parking position candidates. The parking position candidates are displayed to be superimposed on the surrounding image in the look-down image and the bird's-eye image, and the icons 55 are displayed only on the surrounding image in the look-down image in a superimposing manner. The frame of the parking position candidate selected by the cursor is shown by a thick line that is thicker than that of the frames of the other parking position candidates, and the icon 55 corresponding to the parking position candidate selected by the cursor is shown in a darker color than the icons 55 corresponding to the other parking position candidates.

In this way, in the parking search screen, the action plan unit 43 displays multiple parking position candidates on the touch panel 32 so as to be superimposed on the images captured by the external cameras 19 (the look-down image and the bird's-eye image), whereby the occupant can easily understand where in the parking area the multiple parking position candidates displayed on the screen of the touch panel 32 are, and it becomes easy to select from among the multiple undelimited parking spaces.

As shown in FIG. 4B, in the parking screen, the action plan unit 43 displays the target parking position to be superimposed on the look-down image and the bird's-eye image, and also displays the trajectory to the target parking position to be superimposed on the look-down image and the bird's-eye image. Thereby, the target parking position and the trajectory to the target parking position are displayed to be easily recognized by the occupant, whereby the occupant can confirm the travel direction and the trajectory on the screen and check the progress of the autonomous movement operation on the screen.

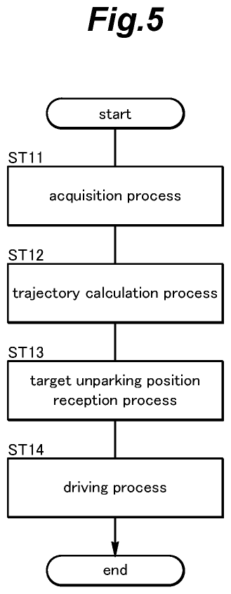

Next, referring to FIG. 5, description will be made of an automatic unparking process executed by the action plan unit 43 when an input is received by the parking main switch 34 in a state where the vehicle is parallel parked between two other vehicles also parallel parked in front of and behind the vehicle, with the travel direction being along the passage.

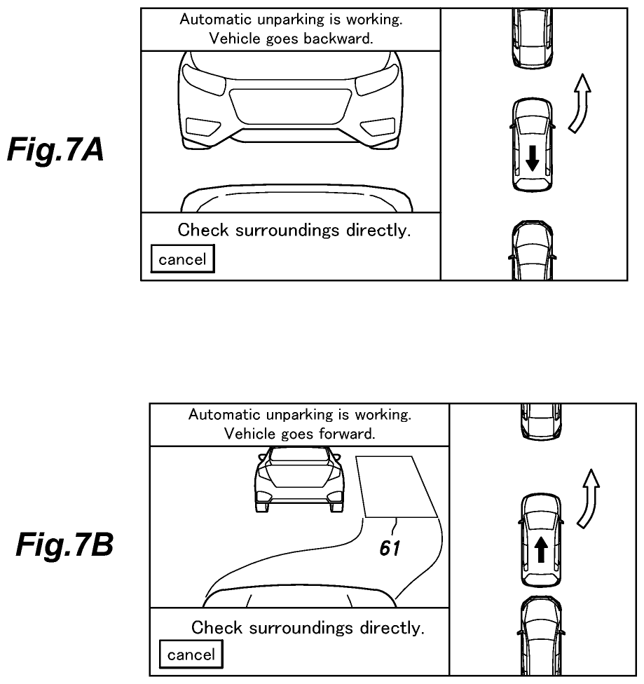

The action plan unit 43 first performs an acquisition process (step S11) to acquire an unparking space 61 (see FIG. 7B) from the external environment recognizing unit 41. More specifically, based on the signal from the external environment sensor 7, the external environment recognizing unit 41 detects the position and size of any obstacle around the own vehicle and also detects a space having a sufficient size for the own vehicle to move to on left and right sides of the vehicle located in front of the own vehicle. The action plan unit 43 acquires the information detected by the external environment recognizing unit 41. In a case where it is determined that there is a sufficient space on each of the left and right sides of the front vehicle, the action plan unit 43 sets an unparking space 61 on each of the left and right sides of the front vehicle. If it is determined that there is a sufficient space on only one of the left and right sides of the front vehicle, the action plan unit 43 sets an unparking space 61 only on the one of the left and right sides of the front vehicle where there is a sufficient space. If it is determined that there is no sufficient space on either of the left and right sides of the front vehicle, the action plan unit 43 displays a message notifying it on the touch panel 32 and terminates the automatic unparking process.

Next, the action plan unit 43 performs a trajectory calculation process (ST12) to calculate a trajectory for unparking the vehicle from the current position to each unparking space 61 based on the positions of other vehicles around the vehicle acquired from the external environment recognizing unit 41. Typically, the action plan unit 43 calculates a trajectory in which the vehicle is first moved backward and then moved to the unparking space 61. When the vehicle can be moved to the unparking space 61 only by forward movement without backward movement, the action plan unit 43 calculates a trajectory in which the vehicle is moved only forward to the unparking space 61.

In a case where the trajectory of the vehicle for a certain unparking space 61 can be calculated, the action plan unit 43 sets the unparking space 61 as an unparking position candidate where the vehicle can be unparked, and make the touch panel 32 display the unparking position candidate on the screen (the unparking search screen). When the trajectory can be calculated for both of the unparking spaces 61 on the left and right sides of the front vehicle, the action plan unit 43 sets both of the unparking spaces 61 as unparking position candidates and make them displayed on the touch panel 32. If the trajectory from the current position to any unparking space 61 cannot be calculated due to the presence of the obstacle, the action plan unit 43 preferably displays a message notifying it on the touch panel 32 and terminates the automatic unparking process.

Next, the action plan unit 43 executes a target unparking position reception process (ST13) to receive a selection operation performed by the occupant to select the target unparking position, which is an unparking position where the occupant wants to unpark the vehicle, and is selected from the unparking position candidates displayed on the touch panel 32. More specifically, the action plan unit 43 causes the look-down image and the bird's-eye image in the travel direction to be displayed in the unparking search screen. Here, the bird's-eye image in the travel direction is a bird's-eye image looking down on the vehicle in the forward direction as shown in FIG. 6 when the shift range is the parking range (parking position), the neutral range, or the drive (forward) range, and a bird's-eye image looking down on the vehicle in the rearward direction as shown in FIG. 6B when the shift range is the reverse range.

When the action plan unit 43 acquires at least one unparking position candidate, the action plan unit 43 displays an arrow indicating the direction of the trajectory to the unparking position candidate to be superimposed on the surrounding image in at least one of look-down image and the bird's-eye image. In the present embodiment, the action plan unit 43 causes an arrow indicating the direction of each trajectory to be displayed in both the look-down image and the bird's-eye image. In this way, the action plan unit 43 causes the touch panel 32 to display the direction of the trajectory to each unparking position candidate to be superimposed on the look-down image and the bird's-eye image in the unparking search screen, whereby the occupant can easily recognize the direction of the trajectory.

Also, the action plan unit 43 causes a notification instructing the driver to set the unparking position (target unparking position) to be displayed in the unparking search screen displayed on the touch panel 32 in order to receive the selection operation of the target unparking position. The selection operation of the target unparking position may be performed via the touch panel 32 or the selection input member 35.

After the target unparking position is selected by the driver, the action plan unit 43 switches the screen of the touch panel 32 from the unparking search screen to the unparking screen, and executes a driving process (ST14) to make the vehicle travel along the calculated trajectory. The action plan unit 43 preferably sets, as a condition for starting the driving process, at least one of an operation input corresponding to the start of driving, an operation of depressing the brake pedal 24, an operation of releasing the parking brake, and an operation of placing the shift lever 25 in a range suitable for the travel direction. In this case, the action plan unit 43 preferably makes a notification instructing the occupant to perform the operation set as the start condition by displaying it on the touch panel 32 or by voice guidance.

In the driving process, the action plan unit 43 controls the vehicle based on the position of the vehicle acquired by the GPS receiving unit 20 and the signals from the external cameras 19, the vehicle sensor 8, and the like so that the vehicle travels along the calculated trajectory. At this time, the action plan unit 43 may control the powertrain 4, the brake device 5, and the steering device 6 so as to execute a switching operation for switching the travel direction of the vehicle repeatedly or once. During the driving process, the action plan unit 43 may acquire the travel direction image from the external cameras 19 and make the touch panel 32 display the acquired travel direction image on the left half thereof.

More specifically, the unparking screen is a screen in which the travel direction image is displayed on the left half of the touch panel 32 and the look-down image including the vehicle and its surrounding area is displayed on the right half thereof. Therefore, when the trajectory includes a backward trajectory, along which the vehicle is first moved backward in the unparking movement, the action plan unit 43 causes the rear image (rear view) of the vehicle captured by the rear camera to be displayed on the left half of the touch panel 32, as shown in FIG. 7A. Also, when the vehicle is moved backward, the action plan unit 43 causes a backward arrow indicating the travel direction to be displayed so as to be superimposed on the image representing the vehicle displayed in the look-down image. This allows the occupant to understand that the vehicle is moved backward.

When the vehicle is moved forward after the backward movement along the backward trajectory is completed or when the trajectory does not include the backward trajectory, the action plan unit 43 causes the front image (front view) of the vehicle captured by the front camera to be displayed on the left half of the touch panel 32, as shown in FIG. 7B. Also, when the vehicle is moved forward, the action plan unit 43 causes a forward arrow indicating the travel direction to be displayed so as to be superimposed on the image representing the vehicle displayed in the look-down image. This allows the occupant to understand that the vehicle is moved forward. At this time, the action plan unit 43 may cause a frame indicating the target unparking position selected from the unparking position candidates (the unparking spaces 61) and the trajectory to the target unparking position to be superimposed on the front image.

When the vehicle state determining unit 46 determines that the vehicle is in the prohibition state during the driving process, the action plan unit 43 displays a notification that the automatic unparking is suspended or canceled on the touch panel 32 and executes a deceleration process to decelerate the vehicle to stop the same. Thus, when there is a predetermined operation input by the occupant via the operation input member 11, the action plan unit 43 executes the deceleration process, whereby uneasiness that would be felt by the occupant if the movement of the vehicle were continued can be avoided.

When the vehicle reaches the target unparking position, the action plan unit 43 stops the vehicle and ends the driving process.

As described with reference to FIGS. 6A and 6B, the action plan unit 43 the causes the touch panel 32 to display the look-down image and the bird's-eye image side by side in the unparking search screen. Thereby, the unparking direction of the vehicle related to each unparking space (unparking position candidate) can be displayed so as to be easily recognized by the occupant. Further, as described with reference to FIGS. 7A and 7B, the action plan unit 43 causes the touch panel 32 to display the look-down image and the travel direction image side by side in the unparking screen. Thereby, the occupant can confirm the travel direction on the screen and check the progress of the autonomous movement operation in the automatic unparking process in the look-down image.

As described above, in the unparking search screen, the action plan unit 43 causes the touch panel 32 to display multiple unparking position candidates (or arrows indicating the directions to the respective unparking position candidates) to be superimposed on the images (the look-down image and the bird's-eye image) obtained from the images captured by the external cameras 19. Thereby, the unparking directions corresponding to the respective unparking position candidates displayed on the screen of the touch panel 32 can be recognized by the occupant even more easily and the selection operation of one of the multiple unparking directions, that is, the setting operation of the target unparking position is facilitated.

As shown in FIG. 7B, in the unparking screen, the action plan unit 43 causes the target unparking position to be displayed so as to be superimposed on at least one of the look-down image and the bird's-eye image, and also causes the trajectory to the unparking space 61 set as the target unparking position to be displayed so as to be superimposed on at least one of the look-down image and the bird's-eye image. Thereby, the target unparking position and the trajectory to the target unparking position are displayed to be easily recognized by the occupant, whereby the occupant can confirm the travel direction and the trajectory on the screen and check the progress of the autonomous movement operation on the screen.

Concrete embodiments of the present invention have been described in the foregoing, but the present invention should not be limited by the foregoing embodiments and various modifications and alterations are possible within the scope of the present invention. For example, the concrete structure, arrangement, number, process content and procedure, etc. of the components/units of the embodiments may be appropriately changed within the scope of the present invention. Also, not all of the structural elements shown in the above embodiments are necessarily indispensable and they may be selectively adopted as appropriate.

1. A parking assist system for autonomously moving a vehicle from a current position to a target position, the system comprising:
an imaging device configured to capture an image of surroundings of the vehicle as a surrounding image;
a target position candidate detector configured to detect at least one target position candidate, each target position candidate consisting of an undelimited parking space defined in a parking area around the vehicle, a delimited parking space around the vehicle, or an unparking space available on a passage;
a display device configured to display the surrounding image and the at least one target position candidate on a screen;
an operation member configured to receive an operation by an occupant of the vehicle; and
a control device configured to control screen display of the display device, to set the target position candidate selected by the occupant via the operation member as the target position, and to control an autonomous movement operation to autonomously move the vehicle to the target position to park or unpark the vehicle,
wherein the control device is configured to perform image processing to convert the surrounding image into a look-down image showing the vehicle and a surrounding area of the vehicle as viewed from above and a bird's-eye image showing the vehicle and a part of the surrounding area positioned in a travel direction of the vehicle as viewed from above in the travel direction, to cause the display device to display the look-down image and the bird's-eye image side by side in a target position setting screen in which the at least one target position candidate is displayed for setting the target position, and to cause the display device to display the look-down image and a travel direction image, which is an image viewed from the vehicle in the travel direction, side by side in an autonomous movement control screen displayed when controlling the autonomous movement operation.

2. The parking assist system according to claim 1, wherein the control device is configured to cause the display device to display the at least one target position candidate in the target position setting screen such that the at least one target position candidate is superimposed on at least one of the look-down image and the bird's-eye image.

3. The parking assist system according to claim 1, wherein the control device is configured to cause the display device to display the target position in the autonomous movement control screen such that the target position is superimposed on at least one of the look-down image and the travel direction image.

4. The parking assist system according to claim 1, wherein the control device is configured to cause the display device to display a trajectory to the target position in the autonomous movement control screen such that the trajectory is superimposed on at least one of the look-down image and the travel direction image.

5. The parking assist system according to claim 1, further comprising an operation input member configured to receive an input of a driving operation of the vehicle by the occupant,
wherein when a predetermined operation input by the occupant is received via the operation input member while moving the vehicle by executing the control of the autonomous movement operation, the control device executes a deceleration process to decelerate and stop the vehicle.
